(19) United States
(12) Patent Application Publication
(10) Pub. No.: US 2026/0105553 A1
(43) Pub. Date: Apr. 16, 2026

(54) SYSTEM AND METHOD FOR PROVIDING FILTERING INFORMATION FOR COPYRIGHT REGISTRATION APPLICATION

(71) Applicant: LSWARE INC., Seoul (KR)

(72) Inventors: Min Soo KIM, Gyeonggi-do (KR); Dong Myung SHIN, Seoul (KR); Yong Joon JOE, Seoul (KR); Won Bin KIM, Gyeonggi-do (KR); Chang Hyun ROH, Seoul (KR)

(21) Appl. No.: 19/351,523

(22) Filed: Oct. 7, 2025

(30) Foreign Application Priority Data
Oct. 10, 2024 (KR) 10-2024-0137649

(51) Int. Cl. G06Q 50/18

(52) U.S. Cl. CPC G06Q 50/184

(57) ABSTRACT

Disclosed is a system for providing filtering information for a copyrighted work registration application includes: a contract management server configured to execute an electronic contract related to use of first copyrighted works between first copyright holders of the first copyrighted works and second copyright holders of second copyrighted works created using the first copyrighted works; and a copyrighted work supply server configured to provide an online supply service for the second copyrighted works in accordance with a supply registration application for online supply of the second copyrighted works, and to generate supply filtering information indicating whether the supply registration application corresponds to the electronic contract concluded with the first copyright holders.

### CROSS-REFERENCE TO RELATED APPLICATION

This application claims priority from Korean Patent Application No. 10-2024-0137649 filed on Oct. 10, 2024 in the Korean Intellectual Property Office, the contents of which in its entirety are herein incorporated by reference.

### FIELD

The present disclosure relates to a technology for providing information on copyrighted works, and more particularly, to a system and method for providing relevant information regarding a registration application on a platform for online supply of a second copyrighted work created from a first copyrighted work.

### BACKGROUND

Although a creator is able to produce an entire copyrighted work from beginning to end, it is also possible to create a second copyrighted work by using a first copyrighted work created by another creator. In particular, works such as movies and games are generally not created by a single creator alone but are usually created by combining first copyrighted works produced by numerous creators into one new second copyrighted work.

The second copyrighted work created in this way is based on the use of numerous first copyrighted works under various license agreements, and must comply with the license agreements for the first copyrighted works used. Furthermore, for various reasons, such as the need in modern times for a process to filter out works of creators with specific ideologies, there is a need for a method to easily verify the conditions under which a second copyrighted work created using a first copyrighted work is used.

### SUMMARY

The present disclosure provides a system and method for providing filtering information on a registration application so that, during the process of registering a second copyrighted work on a supply platform, it is possible to determine whether a second copyrighted work created using a first copyrighted work is being properly used in compliance with a usage contract with a copyright holder of a first copyrighted work.

Other objects and advantages of the present disclosure will be apparent from the following description, and will be more clearly understood by embodiments of the present disclosure. In addition, it will be readily apparent that the objects and advantages of the present disclosure may be realized by the means and combinations thereof set forth in the claims.

According to one aspect of the present disclosure, a system for providing filtering information for a copyrighted work registration application includes: a contract management server configured to execute an electronic contract related to use of first copyrighted works between first copyright holders of the first copyrighted works and second copyright holders of second copyrighted works created using the first copyrighted works; and a copyrighted work supply server configured to provide an online supply service for the second copyrighted works in accordance with a supply registration application for online supply of the second copyrighted works, and to generate supply filtering information indicating whether the supply registration application corresponds to the electronic contract concluded with the first copyright holders.

The contract management server may include: a contract management database configured to store contract condition information including a supply channel item related to supply of the second copyrighted works, a moral rights permission item related to the first copyrighted works in connection with the second copyrighted works, a reuse permission item regarding whether creation of third copyrighted works using the second copyrighted works is permitted, and a fee item related to a method for calculating fees incurred from the supply of the second copyrighted works; a contract conclusion unit configured to execute the electronic contract between the first copyright holders and the second copyright holders using the contract condition information, and to generate contract conclusion information according to the electronic contract; and a contract information extraction unit configured to extract contract conclusion information corresponding to the first copyrighted works serving as the basis for the creation of the second copyrighted works requested from the copyrighted work supply server, and to provide the extracted contract conclusion information to the copyrighted work supply server.

The contract conclusion unit may be further configured, after setting the supply channel item, to set a moral rights permission item corresponding to the supply channel item, to set a reuse permission item corresponding to the moral rights permission item, and then to set a fee item, thereby generating the contract conclusion information including contractual supply channel information, contractual moral rights permission information, contractual reuse permission information, and contractual fee information according to the electronic contract.

The copyrighted work supply server may include: a copyrighted work database configured to store copyrighted work matching information and registration application specification information for the second copyrighted works created using the first copyrighted works; a list information extraction unit configured to, in response to a supply registration application for online supply of the second copyrighted works from a user terminal of each of the second copyright holders, extract first copyrighted work list information for the first copyrighted works serving as the basis for the creation of the second copyrighted works from the copyrighted work matching information; and a filtering information generation unit configured to request contract conclusion information corresponding to each of the first copyrighted works in the first copyrighted work list information from the contract management server, compare the contract conclusion information transmitted from the contract management server with the registration application specification information, and generate, based on a result of the comparison, supply filtering information indicating whether online supply of the second copyrighted works is permitted.

The registration application specification information may include registration application supply channel information, registration application moral rights permission information, registration application reuse permission information, and registration application fee information for the second copyrighted works.

The copyrighted work database may be configured to store, as the copyrighted work matching information, matching information related to a list of the second copyrighted works created using the first copyrighted works and a list of the first copyrighted works used in the creation of the second copyrighted works.

The copyrighted work supply server may further include a copyrighted work interface unit configured to transmit the supply filtering information to the user terminal and to support display of the supply filtering information on the user terminal.

According to another aspect of the present disclosure, a method for providing filtering information for a copyrighted work registration application includes: executing, by a contract management server, an electronic contract related to use of first copyrighted works between first copyright holders of the first copyrighted works and second copyright holders of second copyrighted works created using the first copyrighted works; and providing, by a copyrighted work supply server, an online supply service for the second copyrighted works in response to a supply registration application for online supply of the second copyrighted works, and generating supply filtering information indicating whether the supply registration application corresponds to the electronic contract concluded with the first copyright holders.

The executing of the electronic contract may include storing contract condition information including a supply channel item related to the supply channel of the second copyrighted works, a moral rights permission item related to the first copyrighted works in connection with the second copyrighted works, a reuse permission item indicating whether creation of third copyrighted works using the second copyrighted works is permitted, and a fee item related to a method for calculating fees incurred from the supply of the second copyrighted works; executing the electronic contract between the first copyright holders and the second copyright holders using the contract condition information; and generating contract conclusion information according to the electronic contract.

The generating of the contract conclusion information may include, after setting the supply channel item, setting a moral rights permission item corresponding to the supply channel item; after setting the moral rights permission item, setting a reuse permission item corresponding to the moral rights permission item; and after setting the reuse permission item, setting a fee item, thereby generating the contract conclusion information including contractual supply channel information, contractual moral rights permission information, contractual reuse permission information, and contractual fee information according to the electronic contract.

The generating of the supply filtering information may include: storing work matching information for the second copyrighted works created using the first copyrighted works; extracting, from the work matching information, first copyrighted work list information for the first copyrighted works serving as the basis for the creation of the second copyrighted works, in response to a supply registration application for online supply of the second copyrighted works from a user terminal of each of the second copyright holders; requesting, from the contract management server, contract conclusion information corresponding to the first copyrighted work list information; comparing the contract conclusion information transmitted from the contract management server with the registration application specification information for the second copyrighted works; and generating, based on a result of the comparison, the supply filtering information indicating whether online supply of the second copyrighted works is permitted.

The generating of the supply filtering information may include extracting, by the contract management server, contract conclusion information for the first copyrighted works serving as the basis for the creation of the second copyrighted works requested from the copyrighted work supply server, and providing the extracted contract conclusion information to the copyrighted work supply server.

The registration application specification information may include registration application supply channel information, registration application moral rights permission information, registration application reuse permission information, and registration application fee information for the second copyrighted works.

The work matching information may include matching information related to a list of the second copyrighted works created using the first copyrighted works and a list of the first copyrighted works used in the creation of the second copyrighted works.

The method may further include transmitting the supply filtering information to the user terminal and supporting display of the supply filtering information on the user terminal.

### BRIEF DESCRIPTION OF THE DRAWINGS

The following drawings attached to this specification illustrate preferred embodiments of the present disclosure and, together with specific details for carrying out the present disclosure, serve to facilitate understanding of the technical concept of the present disclosure. Therefore, the present disclosure should not be construed as being limited to the matters described in such drawings.

FIG. 1 is a block diagram illustrating a system for providing filtering information for a copyright registration application according to one embodiment of the present disclosure.

FIG. 2 is a block diagram illustrating a contract management server shown in FIG. 1.

FIG. 3 is a diagram illustrating the process of generating contract condition information by a contract conclusion unit shown in FIG. 2.

FIG. 4 is a reference diagram illustrating the process of generating contract conclusion information by the contract conclusion unit shown in FIG. 2.

FIG. 5 is a block diagram illustrating a copyrighted work supply server shown in FIG. 1.

FIG. 6 is a flowchart illustrating a method for providing filtering information for a copyright registration application according to one embodiment of the present disclosure.

FIG. 7 is a timing diagram illustrating an overall operation process of a system and method for providing filtering information for a copyright registration application.

### DETAILED DESCRIPTION

Hereinafter, embodiments of the present disclosure will be described in detail with reference to the accompanying drawings.

The embodiments of the present disclosure are provided to fully describe the invention to those skilled in the art, and the embodiments described below may be implemented in various forms, and the scope of the present disclosure is not limited thereto. Rather, these embodiments are provided so that this disclosure will be thorough and complete and will fully convey the concept of the invention to those skilled in the art.

The terminology used herein is for the purpose of describing particular embodiments and is not intended to limit the present disclosure. As used herein, the singular form may include the plural form unless the context clearly indicates otherwise. As used herein, the term “and/or” includes any and all combinations of one or more of the listed items. In the present specification, an original copyrighted work is defined as a “first copyrighted work,” and a creator thereof is defined as a “first copyright holder.” A derivative work created using the first copyrighted work is defined as a “second copyrighted work,” and a derivative work created using the second copyrighted work is defined as a “third copyrighted work.” In this sequential manner, derivative works created using preceding works are defined as a “fourth copyrighted work,” . . . an “n-th copyrighted work,”and copyright holders of the respective works are defined in the same manner.

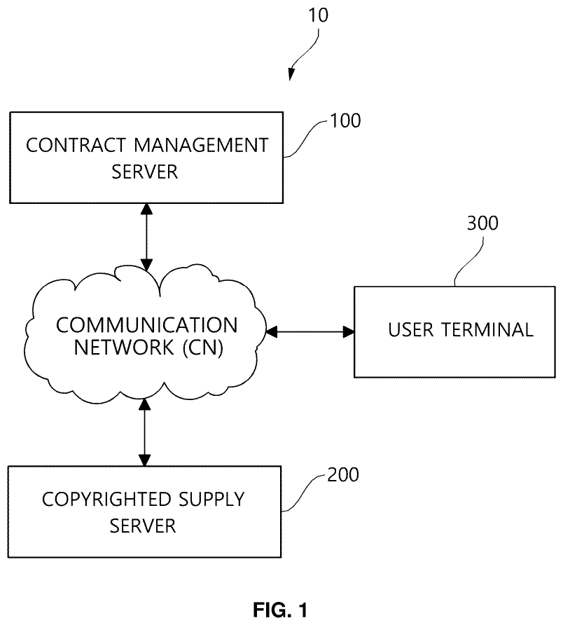

FIG. 1 is a block diagram illustrating a system for providing filtering information for a copyright registration application according to one embodiment of the present disclosure (hereinafter referred to as a filtering information provision system).

Referring to FIG. 1, a filtering information provision system 10 includes a contract management server 100 and a copyrighted work supply server 200. In addition, the filtering information provision system 10 may include a user terminal 300 and a communication network (CN) for network connection between the contract management server 100 and the copyrighted work supply server 200.

The contract management server 100 executes an electronic contract related to the use of first copyrighted works between first copyright holders of the first copyrighted works and second copyright holders of second copyrighted works created using the first copyrighted works, and stores contract conclusion information generated according to the electronic contract.

The electronic contract refers to an electronic contract related to conditions, methods, and scope of use of the first copyrighted works for creating the second copyrighted works.

The electronic contract may be an electronic contract for creating the second copyrighted works using the first copyrighted works, or an electronic contract for creating a third copyrighted work using the second copyrighted works. In this way, the electronic contract includes an electronic contract related to the use of an (n-1)-th copyrighted work between an (n-1)-th copyright holder of the (n-1)-th copyrighted work and an n-th copyright holder of an n-th copyrighted work created using the (n-1)-th copyrighted work.

The copyrighted work supply server 200 provides a copyright supply service for any first or second copyrighted works. The copyrighted work supply service may include services provided through content distribution platforms such as YouTube, Spotify, and Netflix.

In addition, according to a service registration application for supplying the second copyrighted works, the copyrighted work supply server 200 generates supply filtering information by analyzing whether the registration application matches the electronic contract for the first copyrighted works that serve as the basis for the creation of the second copyrighted works.

The user terminal 300 may be used by each first copyright holder or each second copyright holder. The user terminal 300 may include a desktop PC, a mobile device, and the like.

The user terminal 300 is connected to the contract management server 100 or the copyrighted work supply server 200 through the CN. The CN may be a wired communication network, including an Ethernet communication network or a serial (USB) communication network. The communication network may also be a wireless communication network, including wireless Internet (WiFi) or mobile communication networks for services such as 2G to 5G.

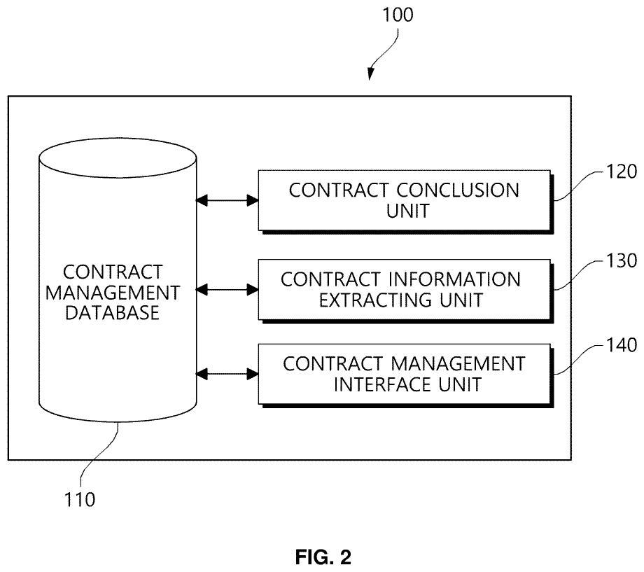

FIG. 2 is a block diagram illustrating the contract management server 100 shown in FIG. 1.

Referring to FIG. 2, the contract management server 100 includes a contract management database 110, a contract conclusion unit 120, a contract information extraction unit 130, and a contract management interface unit 140.

The contract management database 110 stores contract condition information for an electronic contract for copyrighted works.

The contract condition information includes items specifying conditions for the use of copyrighted works, including a supply channel item related to the supply of second copyrighted works, a moral rights permission item related to first copyrighted works in connection with the second copyrighted works, a reuse permission item indicating whether creation of a third copyrighted work using the second copyrighted works is permitted, and a fee item related to a method for calculating fees incurred from the supply of the second copyrighted works.

The supply channel item may include, for example, social networking services (SNS), video platforms (YouTube, Afreeca TV, etc.), CD/DVD/USB, newspapers, websites, TV, and movies. In addition, the moral rights permission item includes a right-of-integrity permission item (concerning the nature of the work, such as sexuality, violence, religious nature, and political nature) and a right-of-attribution permission item (indication of the name of the first copyright holder, indication of credits, etc.).

The contract management database 110 stores contract condition program information, including electronic forms and electronic setting methods, which are configured to enable a user (a first copyright holder, a second copyright holder, or the like) to select and set items such as the supply channel item, the moral rights permission item, the reuse permission item, and the fee item through the user terminal 300. The contract condition program information may be provided to the user terminals 300 of the first copyright holder and the second copyright holder.

In addition, the contract management database 110 stores contract conclusion information generated according to the electronic contract. The contract conclusion information refers to specification information regarding the electronic contract executed based on the contract condition information. The contract management database 110 stores the contract conclusion information mapped to identification information of the first copyrighted works.

The contract conclusion unit 120 executes the contract condition program information, provides an electronic form and electronic setting method for configuring contract conditions to the user terminal 300 of the first copyright holder, and generates contract condition information corresponding to items selected through the user terminal 300 of the first copyright holder.

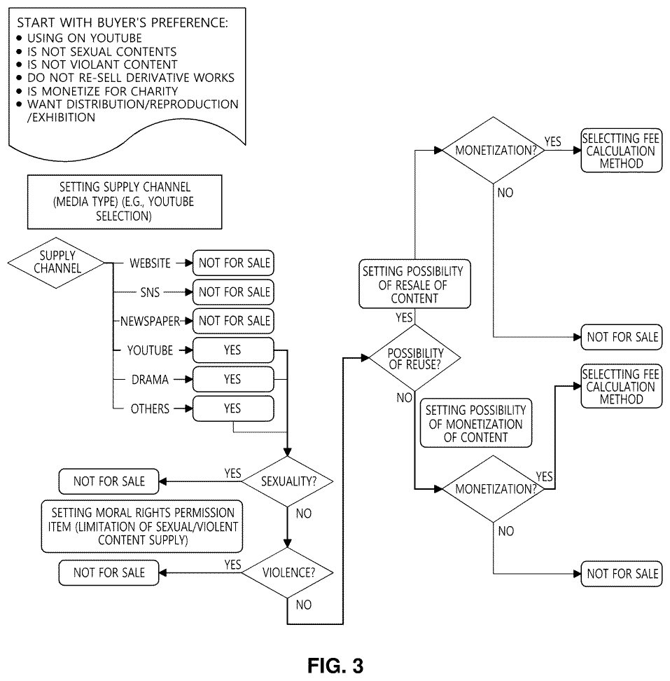

FIG. 3 is a reference diagram illustrating the process of generating contract condition information by the contract conclusion unit 120 shown in FIG. 2.

Referring to FIG. 3, the process is illustrated in which a first copyright holder checks contract condition information through a user terminal of the first copyright holder and sets usage conditions for a first copyrighted work for the first copyright holder. Accordingly, the first copyright holder may set contract condition information for a second copyrighted work created using the first copyrighted work, including a supply channel item (e.g., a platform such as YouTube and an operation channel of a second copyright holder (user) within the platform), a moral rights permission item (e.g., whether sexuality, violence, etc. are permitted), a reuse permission item for the second copyrighted work (whether the reuse is permitted), and a fee item (whether monetization is permitted and the fee calculation method according to individual rights under copyright).

Upon a request from the first copyright holder, the contract conclusion unit 120 may create and register a contract condition program to permit the use of the first copyrighted work based on a supply channel item, a moral rights permission item, whether monetization is permitted, whether the reuse of the first copyrighted work is permitted, and the like. This program may be applied to one work or to multiple works.

Thereafter, the contract conclusion unit 120 executes an electronic contract for copyrighted works between the first copyright holder and the second copyright holder using the contract condition information stored in the contract management database 110, and generates contract conclusion information according to the electronic contract and stores the contract conclusion information in the contract management database 110. The contract conclusion information refers to information regarding the electronic contract executed based on the contract condition information.

To this end, as shown in FIG. 3, the contract conclusion unit 120 provides the contract condition information to the user terminal 300 of the second copyright holder, and generates contract conclusion information corresponding to electronic contract items set according to the contract condition information through the user terminal 300 of the second copyright holder.

The contract conclusion unit 120, after setting a supply channel item for the second copyrighted work, sets a moral rights permission item corresponding to the supply channel item, subsequently sets a reuse permission item corresponding to the moral rights permission item, and then sets a fee item. The contract conclusion unit 120 thereby generates contract conclusion information including contractual supply channel information, contractual moral rights permission information, contractual reuse permission information, and contractual fee information according to the electronic contract.

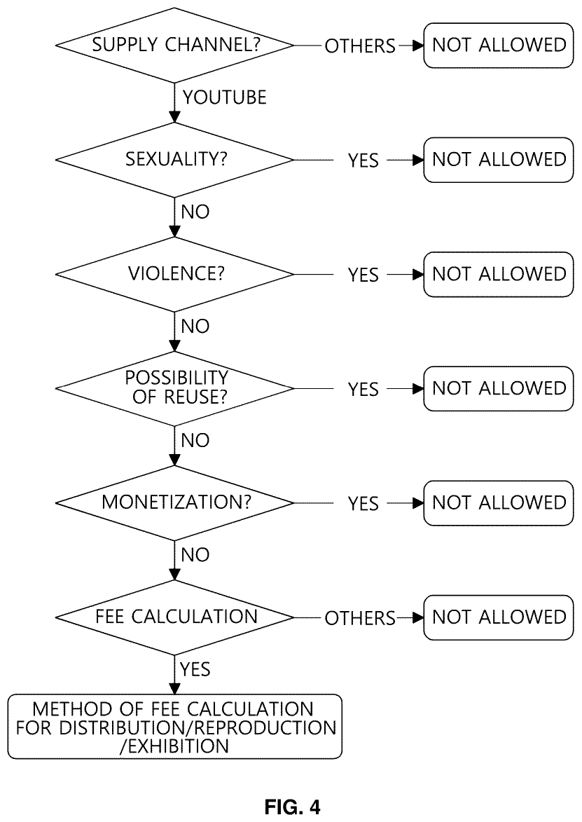

FIG. 4 is a reference diagram illustrating the process of generating contract conclusion information by the contract conclusion unit 120 shown in FIG. 2.

Referring to FIG. 4, the contract conclusion information includes information corresponding to electronic contract items sequentially selected or set by a second copyright holder (i.e., the person who intends to create or has created a second copyrighted work using a first copyrighted work) according to the contract condition information. That is, the contract conclusion information includes contractual supply channel information, contractual moral rights permission information, contractual reuse permission information, and contractual fee information.

For example, the contract conclusion unit 120 sets contractual supply channel information for the second copyrighted work based on one or more items selected by the second copyright holder, such as a website, an SNS, a newspaper outlet, a YouTube channel, or a drama. According to the set contractual supply channel information, the contract conclusion unit 120 sets contractual moral rights permission information based on one or more items selected by the second copyright holder, including a permission item for the right of integrity (e.g., sexuality, violence, religion, politics) or a permission item for the right of attribution (e.g., indication of the name of the first copyright holder, indication of credits). Then, according to the set contractual moral rights permission information, the contract conclusion unit 120 sets contractual reuse permission information of the second copyrighted work (e.g., whether creation of a third copyrighted work using the second copyrighted work is permitted). After setting the contractual reuse permission information, the contract conclusion unit 120 sets contractual fee information (e.g., fee settlement date, settlement method, etc.) according to monetization of the second copyrighted work, and generates the contract conclusion information through these settings.

From the perspective of the second copyright holder, the second copyright holder sequentially inputs necessary information as contract conclusion information, such as the intended use (supply channel information) and method of use (e.g., a political propaganda, a provocative movie, an educational SNS advertisement, and the like) of the second copyrighted work to be created, through the contract management server 100. This information is as shown in FIG. 4. When this information is input, the contract conclusion unit 120 generates contract conclusion information corresponding to the input information for each first copyrighted work.

The information input to the contract conclusion unit 120 is supply channel information, which corresponds to one or more channels input by the second copyright holder. If a channel not permitted by the first copyright holder of the first copyrighted work is selected, a contract is not concluded and contract conclusion information is not generated. The user may select two or more supply channels (e.g., YouTube and TV). Thereafter, depending on the selection of a supply channel, the second copyright holder responds to an inquiry regarding the moral rights permission items designated by the first copyright holder. For example, in FIG. 4, if the first copyright holder requires permission for the right of integrity among the moral rights items (particularly, permission to sexuality and violence), the creation of the second copyrighted work including sexuality and violence may not be permitted.

Thereafter, whether the reuse of the first copyrighted work (i.e., the right to create a derivative copyrighted work using the first copyrighted work) is permitted is determined. In FIG. 4, if the reuse of the first copyrighted work is permitted, contract conclusion information requiring higher royalties may be generated.

Thereafter, whether monetization of the second copyrighted work is permitted is determined, and if so, contract conclusion information requiring higher royalties may be generated.

Thereafter, the monetization purpose and method are identified (e.g., Proprietary: direct monetization, Charity: monetization for donations, and Advertise: monetization based on expected advertising revenue).

Finally, according to a contract such as that shown in FIG. 4, which is generated based on the conditions set by the copyright holder of the first copyrighted work, the creator of the second copyrighted work concludes a license agreement based on contract conclusion information finally generated by FIG. 4.

As described above, depending on the supply channel information, moral rights permission information, reuse permission information, and fee information sequentially selected by the second copyright holder, the contract conclusion unit 120 may generate various types of contract conclusion information, which may include conditions such as fee information (e.g., lump-sum payment, running guarantee, composite method, and penalty for violation), permitted copyright types (e.g., transmission rights, reproduction rights, and exhibition rights), genre of the second copyrighted work, and the number of uses.

The contract information extraction unit 130 extracts contract conclusion information corresponding to first copyrighted work list information for first copyrighted works serving as the basis for the creation of second copyrighted works requested from the copyrighted work supply server 200, and provides the extracted contract conclusion information to the copyrighted work supply server 200.

Upon receiving the first copyrighted work list information from the copyrighted work supply server 200, the contract information extraction unit 130 may extract contract conclusion information corresponding to the first copyrighted work list information from the contract management database 110 using identification information of the first copyrighted works included in the first copyrighted work list information. The contract information extraction unit 130 transmits the extracted contract conclusion information to the copyrighted work supply server 200.

The contract management interface unit 140 provides a user interface (UI) to the user terminal 300 to allow inputting a search condition for contract condition information and contract conclusion information.

When a request for electronic contract conclusion is received from the user terminal 300, the contract management interface unit 140 extracts contract condition information for an electronic contract from the contract management database 110 and supports displaying the contract condition information on the user terminal 300.

Thereafter, as the contract condition information is displayed on the user terminal 300, each first copyright holder or second copyright holder (the person using a corresponding first copyrighted work) may set conditions of the use for the corresponding first copyrighted work or second copyrighted work according to the displayed contract condition information. Accordingly, the contract management interface unit 140 provides the setting information for the electronic contract, which is supplied from the user terminal 300, to the contract conclusion unit 120, to execute the electronic contract.

In addition, the contract management interface unit 140 may allow additional conditions not yet reflected to be set in addition to the conditions input in advance, and may support displaying contract conclusion information corresponding to the conclusion of the electronic contract on the user terminal 300. Accordingly, the contract conclusion information is displayed on the user terminal 300.

In addition, the contract management interface unit 140 may provide information for setting a fee calculation condition and may control the display of a simulation result on the user terminal 300 based on the set fee calculation condition. At this point, the contract management interface unit 140 may allow adjustment of only a variable used in the fee calculation condition, display a change in the settlement amount through the adjustment of the variable, and control the display of a corresponding change graph.

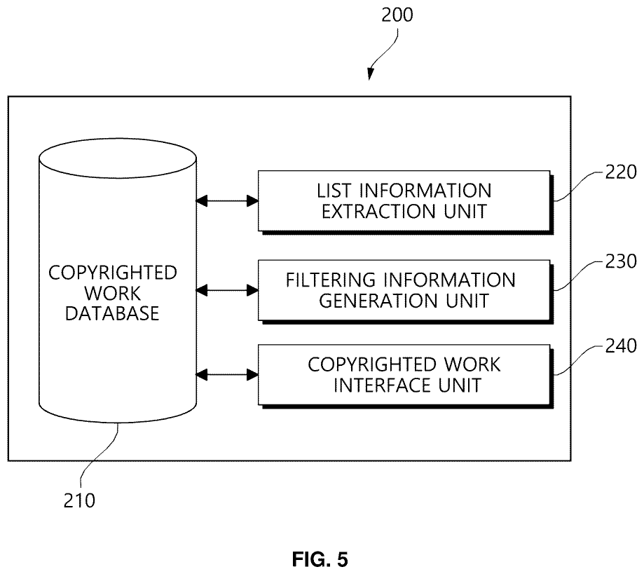

FIG. 5 is a block diagram illustrating the copyrighted work supply server 200 shown in FIG. 1.

Referring to FIG. 5, the copyrighted work supply server 200 includes a copyrighted work database 210, a list information extraction unit 220, a filtering information generation unit 230, and a copyrighted work interface unit 240.

The copyrighted work database 210 stores registration application specification information and copyrighted work matching information for each second copyrighted work.

The registration application specification information refers to information provided by an applicant upon application for registration of a second copyrighted work supply service, and the copyrighted work database 210 stores the registration application specification information transmitted through a user terminal 300 in the course of registration of a second copyrighted work.

A second copyright holder wants his or her second copyrighted work to be supplied online through a copyrighted work supply channel. The second copyright holder connects the user terminal 300 to the copyrighted work supply server 200 and applies for registration of an online supply service for his or her second copyrighted work.

The copyrighted work supply server 200 may provide a user interface (UI) to the user terminal 300 to enable the second copyright holder to input registration application specification information via the user terminal 300, and the registration application specification information provided via the user terminal 300 may be stored in the copyrighted work database 210.

The registration application specification information includes registration application supply channel information, registration application moral rights permission information, registration application reuse permission information, and registration application fee information for the second copyrighted work.

The registration application supply channel information refers to information on a channel through which the second copyrighted work is to be supplied. The registration application moral rights permission information refers to information on a permission item for the right of integrity (e.g., sexuality, violence, religion, politics) or a permission item for the right of attribution (e.g., indication of the name of a first copyright holder, indication of credits) of the second copyrighted work related to the first copyrighted work. The registration application reuse permission information refers to information on whether the creation of a third copyrighted work using the second copyrighted work is permitted. The registration application fee information refers to a method for calculating fees incurred in the supply of the second copyrighted work.

The copyrighted work matching information includes identification information for each first copyrighted work and each second copyrighted work, and also includes matching information between a list of second copyrighted works created using first copyrighted works and a list of the first copyrighted works used in the creation of the second copyrighted works.

When a registration request for supply of a second copyrighted work is received from the user terminal 300, the list information extraction unit 220 extracts first copyrighted work list information for the first copyrighted works serving as the basis for creation of the second copyrighted works from the copyrighted work matching information.

By comparing identification information of the second copyrighted work, for which supply registration has been applied, with the copyrighted work matching information stored in the copyrighted work database 210, the list information extraction unit 220 may extract the first copyrighted work list information for the first copyrighted works serving as the basis for creation of the second copyrighted work.

The filtering information generation unit 230 compares the contract conclusion information provided from the contract management server 100 with the registration application specification information stored in the copyrighted work database 210, and generates, based on a result of the comparison, supply filtering information indicating whether online supply of the second copyrighted work for which supply registration has been applied is allowed. The supply filtering information refers to information using contract conclusion information on whether a second copyrighted work, for which the online supply service has been requested, has been lawfully created from the first copyrighted works in accordance with the electronic contract for copyrighted works.

In order to generate the supply filtering information, the contract conclusion information stored in the contract management server 100 is required. Accordingly, the filtering information generation unit 230 requests the contract management server 100 to provide contract conclusion information related to the first copyrighted works that serve as the basis for the creation of the second copyrighted work. When requesting contract conclusion information from the contract management server 100, the filtering information generation unit 230 may transmit the first copyrighted work list information, extracted from the list information extraction unit 220, together with a request signal for the contract conclusion information.

Accordingly, the contract management server 100 compares the first copyrighted work list information transmitted from the copyrighted work supply server 200 with the information stored in the contract management database 110, extracts contract conclusion information corresponding to the first copyrighted work list information, and transmits the extracted contract conclusion information to the copyrighted work supply server 200.

When the contract conclusion information is received from the contract management server 100, the filtering information generation unit 230 may compare contract conclusion information for each first copyrighted work (e.g., contractual supply channel information, contractual moral rights permission information, contractual reuse permission information, and contractual fee information for the second copyrighted work) with the registration application specification information for the second copyrighted work stored in the copyrighted work database 210 (e.g., registration application supply channel information, registration application moral rights permission information, registration application reuse permission information, and registration application fee information), and generate supply filtering information for the second copyrighted work based on a result of the comparison.

When the contract conclusion information for each of the first copyrighted works and the registration application specification information of the second copyrighted work match, the filtering information generation unit 230 may generate registration application permission information as supply filtering information indicating that the creation of the second copyrighted work complies with the electronic contract for copyrighted works. In addition, when there is a mismatch between the contract conclusion information for at least one of the first copyrighted works and the registration application specification information of the corresponding second copyrighted work, the filtering information generation unit 230 may generate registration application rejection information as supply filtering information indicating that the creation of the second copyrighted work does not comply with the electronic contract for copyrighted works.

The copyrighted work supply server 200 may include a copyrighted work interface unit 240 configured to provide the generated supply filtering information to a user terminal 300.

The copyrighted work interface unit 240 may support displaying the supply filtering information on the user terminal 300 of the second copyright holder accessing the copyrighted work supply server 200. To this end, the copyrighted work interface unit 240 is connected to the user terminal 300 through a communication network (CN).

The copyrighted work interface unit 240 provides a user interface (UI) to the user terminal 300 to allow inputting a search condition for supply filtering information, and may provide a user interface configured to display the supply filtering information corresponding to the search condition. Accordingly, the supply filtering information may be displayed on the user terminal 300.

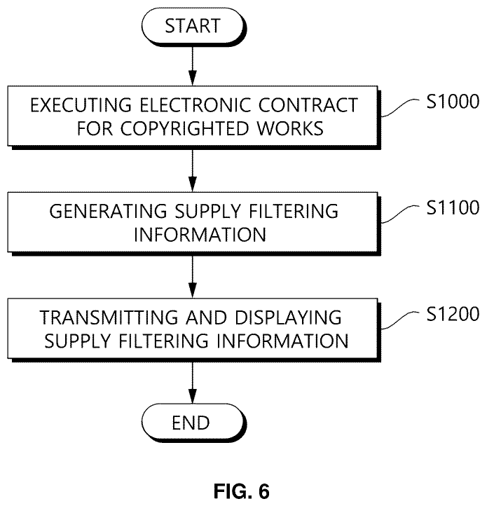

FIG. 6 is a flowchart illustrating a method for providing filtering information for a copyright registration application according to one embodiment of the present disclosure.

First, the contract management server executes an electronic contract related to the use of first copyrighted works between first copyright holders of the first copyrighted works and second copyright holders of second copyrighted works created using the first copyrighted works, and stores contract conclusion information generated according to the electronic contract in operation S1000.

The contract management server stores contract condition information for the electronic contract. The contract condition information includes items specifying conditions for the use of copyrighted works, including a supply channel item related to the supply of the second copyrighted works, a moral rights permission item related to the first copyrighted works in connection with the second copyrighted works, a reuse permission item indicating whether creation of third copyrighted works using the second copyrighted works is permitted, and a fee item related to a method for calculating fees incurred from the supply of the second copyrighted works.

The contract management server uses the contract condition information to execute the electronic contract between the first copyright holders and the second copyright holders, and generates contract conclusion information generated according to the electronic contract. The contract conclusion information refers to information regarding the electronic contract executed based on the contract condition information.

The contract management server provides the contract condition information to the user terminals of the first and second copyright holders, and generates contract conclusion information generated according to electronic contract conditions set according to the contract condition information through the user terminals of the first and second copyright holders.

The contract conclusion unit, after setting a supply channel item for the second copyrighted works, sets a moral rights permission item corresponding to the supply channel item, sets a reuse permission item corresponding to the moral rights permission item, and then sets a fee item. The contract conclusion unit 120 thereby generates contract conclusion information including contractual supply channel information, contractual moral rights permission information, contractual reuse permission information, and contractual fee information according to the electronic contract.

After operation S1000, the copyrighted work supply server provides an online supply service for the second copyrighted work in accordance with a supply registration application for the online supply of the second copyrighted work, and generates supply filtering information on whether the supply registration application complies with the electronic contract concluded with the first copyright holder, in operation S1100.

The copyrighted work supply server stores registration application specification information and copyrighted work matching information for each second copyrighted work.

The registration application specification information includes registration application supply channel information, registration application moral rights permission information, registration application reuse permission information, and registration application fee information for a second copyrighted work. In addition, the copyrighted work matching information includes identification information for each first copyrighted work and second copyrighted work, and also includes matching information between a list of second copyrighted works created using first copyrighted works and a list of the first copyrighted works used in the creation of the second copyrighted works.

When a supply registration application for a second copyrighted work is received from a user terminal, the copyrighted work supply server extracts first copyrighted work list information for first copyrighted works that serve as the basis for the creation of the second copyrighted work from the copyrighted work matching information.

By comparing the identification information of the second copyrighted work, for which supply registration has been applied, with the information included in the copyrighted work matching information, the copyrighted work supply server may extract the first copyrighted work list information.

Thereafter, the copyrighted work supply server compares the contract conclusion information provided from the contract management server with the registration application specification information, and generates, based on a result of the comparison, supply filtering information indicating whether the online supply of the second copyrighted work for which supply registration has been applied is permitted. The supply filtering information refers to information using contract conclusion information on whether a second copyrighted work subject to a request for an online supply service has been lawfully created from first copyrighted works in accordance with an electronic contract for copyrighted works.

In order to generate such supply filtering information, contract conclusion information stored in the contract management server is required. Accordingly, the copyrighted work supply server requests the contract management server for contract conclusion information related to the first copyrighted works that serve as the basis for the creation of the second copyrighted work. When requesting the contract conclusion information from the contract management server, the supply filtering information generation unit may transmit the first copyrighted work list information to the contract management server together with a request signal for the contract conclusion information.

Accordingly, the contract management server extracts contract conclusion information corresponding to the first copyrighted work list information transmitted from the copyrighted work supply server and transmits the extracted contract conclusion information to the copyrighted work supply server.

When the contract conclusion information is received from the contract management server, the copyrighted work supply server may generate supply filtering information for the second copyrighted work by comparing the contract conclusion information for each first copyrighted work (e.g., contractual supply channel information, contractual moral rights permission information, contractual reuse permission information, and contractual fee information for the second copyrighted work) with the registration application specification information for the second copyrighted work stored in the copyrighted work database (e.g., registration application supply channel information, registration application moral rights permission information, registration application reuse permission information, and registration application fee information).

When the contract conclusion information for each of the first copyrighted works and the registration application specification information of the corresponding second copyrighted work match, the copyrighted work supply server may generate registration application permission information as supply filtering information indicating that the creation of the second copyrighted work complies with the electronic contract for copyrighted works. In addition, when there is a mismatch between the contract conclusion information for at least one of the first copyrighted works and the registration application specification information of the second copyrighted work, the copyrighted work supply server may generate registration application rejection information as supply filtering information indicating that the creation of the second copyrighted work does not comply with the electronic contract for copyrighted works.

After operation S1100, the copyrighted work supply server transmits supply filtering information to the user terminal and supports displaying the supply filtering information on the user terminal in operation S1200. The supply filtering information is displayed on the user terminal with the support of the copyrighted work supply server.

The copyrighted work supply server provides a user interface (UI) to the user terminal for entering a search condition for supply filtering information, and further provides a user interface for displaying supply filtering information corresponding to the search condition. Accordingly, the supply filtering information may be displayed on the user terminal.

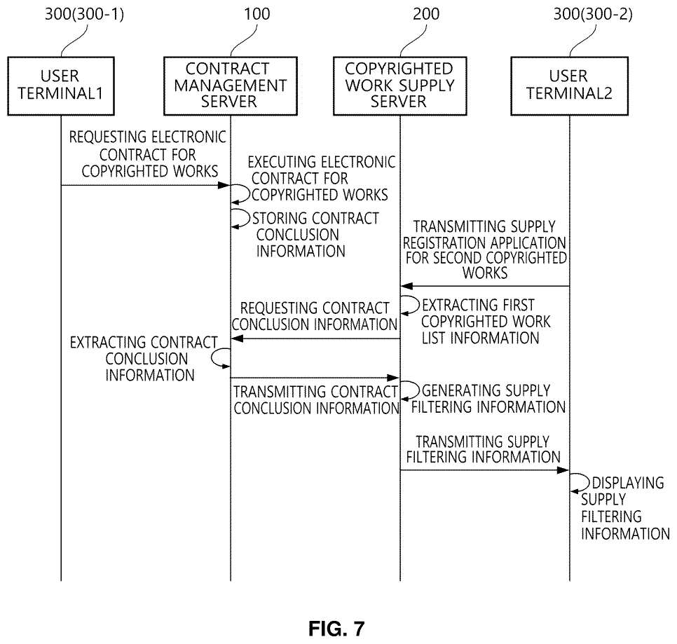

FIG. 7 is a timing diagram illustrating an overall operation process of a system and method for providing filtering information for a copyright registration application.

First, when a request signal for an electronic contract for copyrighted works is received from a user terminal 300-1 of a first or second copyright holder, the contract management server 100 executes an electronic contract for copyrighted works between the first and second copyright holders using contract condition information. The contract management server 100 stores contract conclusion information generated according to the electronic contract.

Thereafter, when a supply registration application for an online supply service of a second copyrighted work created using a first copyrighted work is received from a user terminal 300-2 of the second copyright holder, the copyrighted work supply server 200 extracts first copyrighted work list information that serves as the basis for the second copyrighted work for which supply registration has been applied. Thereafter, the copyrighted work supply server 200 transmits a request signal for contract conclusion information to the contract management server 100, along with the extracted first copyrighted work list information.

The contract management server 100 extracts the contract conclusion information for first copyrighted works that serve as the basis for the creation of the second copyrighted work using the first copyrighted work list information transmitted from the copyrighted work supply server 200, and transmits the extracted contract conclusion information to the copyrighted work supply server 200.

The copyrighted work supply server 200 generates supply filtering information for the second copyrighted work by comparing the contract conclusion information transmitted from the contract management server 100 with the registration application specification information, transmits the generated supply filtering information to the user terminal 300-2, and displays the supply filtering information on a display screen of the user terminal 300-2.

According to the present disclosure, by enabling a copyrighted work supply server providing a supply service to check supply filtering information indicating whether a second copyrighted work for which registration has been applied for an online supply service has been created from a first copyrighted work in compliance with the electronic contract for copyrighted works, it is possible for a supplier of the second copyrighted work to easily check information on the legality of the second copyrighted work supplied on a platform of the supplier.

According to the present disclosure, since supply filtering information indicating whether a second copyrighted work is created in accordance with an electronic contract for copyrighted works can be checked during a process of registering the second copyrighted work on a copyrighted work supply server, a supplier of the second copyrighted work may easily verify whether the second copyrighted work is lawfully supplied on the supplier's platform.

In other words, the supplier of the second copyrighted work may easily verify, through the supply filtering information, whether the second copyrighted work supplied on the supplier's platform is lawfully created from the first copyrighted work in accordance with the electronic contract for copyrighted works, and may prevent disputes arising during the supply of the second copyrighted work among a first copyright holder, a second copyright holder, and the supplier.

The effects obtainable from the present disclosure are not limited to those mentioned above, and other effects not mentioned will be apparent to a person having ordinary skill in the art from the following description.

Although the above description focuses on examples, these are merely examples and do not limit the present disclosure. Those skilled in the art will appreciate that various modifications and applications not exemplified above are possible without departing from the essential characteristics of the present disclosure. For example, each component specifically shown in the examples may be modified and implemented without departing from the scope of the present disclosure. Accordingly, the differences related to these modifications and applications should be construed as being included within the scope of the present disclosure as defined in the appended claims.

What is claimed is:

1. A system for providing filtering information for a copyrighted work registration application, comprising:
a contract management server configured to execute an electronic contract related to use of first copyrighted works between first copyright holders of the first copyrighted works and second copyright holders of second copyrighted works created using the first copyrighted works; and
a copyrighted work supply server configured to provide an online supply service for the second copyrighted works in accordance with a supply registration application for online supply of the second copyrighted works, and to generate supply filtering information indicating whether the supply registration application complies with the electronic contract concluded with the first copyright holders.

2. The system of claim 1, wherein the contract management server comprises:
a contract management database configured to store contract condition information comprising a supply channel item related to supply of the second copyrighted works, a moral rights permission item related to the first copyrighted works in connection with the second copyrighted works, a reuse permission item regarding whether creation of third copyrighted works using the second copyrighted works is permitted, and a fee item related to a method for calculating fees incurred from the supply of the second copyrighted works;
a contract conclusion unit configured to execute the electronic contract between the first copyright holders and the second copyright holders using the contract condition information, and to generate contract conclusion information according to the electronic contract; and
a contract information extraction unit configured to extract contract conclusion information corresponding to the first copyrighted works serving as the basis for the creation of the second copyrighted works requested from the copyrighted work supply server, and to provide the extracted contract conclusion information to the copyrighted work supply server.

3. The system of claim 2, wherein the contract conclusion unit is further configured, after setting the supply channel item, to set a moral rights permission item corresponding to the supply channel item, to set a reuse permission item corresponding to the moral rights permission item, and then to set a fee item, thereby generating the contract conclusion information comprising contractual supply channel information, contractual moral rights permission information, contractual reuse permission information, and contractual fee information according to the electronic contract.

4. The system of claim 1, wherein the copyrighted work supply server comprises:
a copyrighted work database configured to store copyrighted work matching information and registration application specification information for the second copyrighted works created using the first copyrighted works;
a list information extraction unit configured to, in response to a supply registration application for online supply of the second copyrighted works from a user terminal of each of the second copyright holders, extract first copyrighted work list information for the first copyrighted works serving as the basis for the creation of the second copyrighted works from the copyrighted work matching information; and
a filtering information generation unit configured to request contract conclusion information corresponding to each of the first copyrighted works in the first copyrighted work list information from the contract management server, compare the contract conclusion information transmitted from the contract management server with the registration application specification information, and generate, based on a result of the comparison, supply filtering information indicating whether online supply of the second copyrighted works is permitted.

5. The system of claim 4, wherein the registration application specification information comprises registration application supply channel information, registration application moral rights permission information, registration application reuse permission information, and registration application fee information for the second copyrighted works.

6. The system of claim 4, wherein the copyrighted work database is configured to store, as the copyrighted work matching information, matching information related to a list of the second copyrighted works created using the first copyrighted works and a list of the first copyrighted works used in the creation of the second copyrighted works.

7. The system of claim 4, wherein the copyrighted work supply server further comprises a copyrighted work interface unit configured to transmit the supply filtering information to the user terminal and to support display of the supply filtering information on the user terminal.

8. A method for providing filtering information for a copyrighted work registration application, the method comprising:
executing, by a contract management server, an electronic contract related to use of first copyrighted works between first copyright holders of the first copyrighted works and second copyright holders of second copyrighted works created using the first copyrighted works; and
providing, by a copyrighted work supply server, an online supply service for the second copyrighted works in response to a supply registration application for online supply of the second copyrighted works, and generating supply filtering information indicating whether the supply registration application complies with the electronic contract concluded with the first copyright holders.

9. The method of claim 8, wherein the executing of the electronic contract comprises:
storing contract condition information including a supply channel item related to the supply channel of the second copyrighted works, a moral rights permission item related to the first copyrighted works in connection with the second copyrighted works, a reuse permission item indicating whether creation of third copyrighted works using the second copyrighted works is permitted, and a fee item related to a method for calculating fees incurred from the supply of the second copyrighted works;
executing the electronic contract between the first copyright holders and the second copyright holders using the contract condition information; and
generating contract conclusion information according to the electronic contract.

10. The method of claim 9, wherein the generating of the contract conclusion information comprises:
after setting the supply channel item, setting a moral rights permission item corresponding to the supply channel item;
after setting the moral rights permission item, setting a reuse permission item corresponding to the moral rights permission item; and
after setting the reuse permission item, setting a fee item, thereby generating the contract conclusion information including contractual supply channel information, contractual moral rights permission information, contractual reuse permission information, and contractual fee information according to the electronic contract.

11. The method of claim 8, wherein the generating of the supply filtering information comprises:
storing work matching information for the second copyrighted works created using the first copyrighted works;
extracting, from the work matching information, first copyrighted work list information for the first copyrighted works serving as the basis for the creation of the second copyrighted works, in response to a supply registration application for online supply of the second copyrighted works from a user terminal of each of the second copyright holders;
requesting, from the contract management server, contract conclusion information corresponding to the first copyrighted work list information; and
comparing the contract conclusion information transmitted from the contract management server with the registration application specification information for the second copyrighted works, and generating, based on a result of the comparison, the supply filtering information indicating whether online supply of the second copyrighted works is permitted.

12. The method of claim 11, wherein the generating of the supply filtering information comprises:
extracting, by the contract management server, contract conclusion information for the first copyrighted works serving as the basis for the creation of the second copyrighted works requested from the copyrighted work supply server; and
providing the extracted contract conclusion information to the copyrighted work supply server.

13. The method of claim 11, wherein the registration application specification information comprises registration application supply channel information, registration application moral rights permission information, registration application reuse permission information, and registration application fee information for the second copyrighted works.

14. The method of claim 11, wherein the work matching information comprises matching information related to a list of the second copyrighted works created using the first copyrighted works and a list of the first copyrighted works used in the creation of the second copyrighted works.

15. The method of claim 11, further comprising transmitting the supply filtering information to the user terminal and supporting display of the supply filtering information on the user terminal.
